(19) United States
(12) Patent Application Publication
(10) Pub. No.: US 2013/0282374 A1
(43) Pub. Date: Oct. 24, 2013

(54) SPEECH RECOGNITION DEVICE, SPEECH RECOGNITION METHOD, AND SPEECH RECOGNITION PROGRAM

(71) Applicants: Koji Okabe, Minato-ku (JP); Ken Hanazawa, Minato-ku (JP); Seiya Osada, Minato-ku (JP)

(72) Inventors: Koji Okabe, Minato-ku (JP); Ken Hanazawa, Minato-ku (JP); Seiya Osada, Minato-ku (JP)

(73) Assignee: NEC CORPORATION, Tokyo (JP)

(21) Appl. No.: 13/977,382

(22) PCT Filed: Jan. 5, 2012
(86) PCT No.: PCT/JP2012/000044

§ 371 Date: Jun. 28, 2013

(30) Foreign Application Priority Data
Jan. 7, 2011 (JP) 2011-002306

(51) Int. Cl. G10L 15/00

(52) U.S. Cl. CPC G10L 15/00
USPC 704/236

(57) ABSTRACT

A speech recognition device has: hypothesis search means which searches for an optimal solution of inputted speech data by generating a hypothesis which is a bundle of words which are searched for as recognition result candidates; self-repair decision means which calculates a self-repair likelihood of a word or a word sequence included in the hypothesis which is being searched for by the hypothesis search means, and decides whether or not self-repair of the word or the word sequence is performed; and transparent word hypothesis generation means which, when the self-repair decision means decides that the self-repair is performed, generates a transparent word hypothesis which is a hypothesis which regards as a transparent word a word or a word sequence included in an un-repaired interval related to the word or the word sequence, and the hypothesis search means searches hypotheses for an optimal solution, the hypotheses including as search target hypotheses the transparent word hypothesis generated by the transparent word hypothesis generation means.

### TECHNICAL FIELD

The present is concerning a speech recognition device, a speech recognition method, and a speech recognition program.

### BACKGROUND ART

In recent years, an application of a speech recognition technique develops, and a speech recognition technique is used for a speech from people to machines and a more natural speech from people to people. When speech recognition is performed targeting at a speech from people to people, causes of speech recognition error include self-repair and hesitation.

Self-repair refers to a phenomenon that a given word sequence is sounded as is or another word sequence is sounded. Hesitation refers to a phenomenon that, although a given word is partially sounded, the speech is stopped halfway. Hereinafter, as to self-repair, an interval in which self-repair is performed upon subsequent speech is referred to as a “un-repaired interval”, an interval in which self-repair is performed to repair an antecedent speech interval is referred to as a “self-repaired interval”, and an interval which connects these two intervals is referred to as a “self-repair interval”. The un-repaired interval is frequently accompanied by hesitation.

Patent Literature 1 discloses a speech recognition device which can robustly recognize speech including self-repair and hesitation. In the speech recognition device disclosed in Patent Literature 1, speech recognition means receives an input of speech data and performs speech recognition by searching for which word sequence is sounded using a hypothesis search unit, and an interval recognition unit receives an input of a speech recognition result, hypothesizes an un-repaired interval and a self-repaired interval and recognizes an un-repaired interval again. Meanwhile, the interval recognition unit hypothesizes each segment as a self-repaired interval and a previous segment as an un-repaired interval, and sequentially recognizes an un-repaired interval again using as a dictionary a word of the self-repaired interval and a subword of a synonym of this word. Further, a decision unit decides which one of the original recognition result and an interval recognition result is more likely as a speech recognition result, and an output unit outputs a speech recognition result which is decided to be likely.

### CITATION LIST

### Patent Literature

PLT 1: Patent 2010-079092

### SUMMARY OF INVENTION

### Technical Problem

However, a speech recognition result of a self-repaired interval is influenced by a recognition error of an un-repaired interval, and frequently has a recognition error. In this case, according to a method of, for example, performing processing of repairing a speech recognition result after speech recognition is finished as in the speech recognition device disclosed in Patent Literature 1, if self-repair is not accurately recognized, processing for self-repair cannot be normally performed. That is, when a sound including self-repair is self-recognized, a word bundle of a repaired portion becomes improper, and therefore a language likelihood of the word bundle in this interval becomes low and a recognition error of the corrected portion frequently occurs. Thus, when a recognition error is caused at a stage of speech recognition, it is not possible to accurately repair this recognition error.

When, for example, the speech recognition device disclosed in Patent Literature 1 causes a recognition error on the self-repair interval, a recognition error result of a self-repaired interval does not become a correct solution subword of the un-repaired interval. Hence, there is a problem that it is not possible to accurately generate a dictionary for recognizing an un-repaired interval again and output a correct recognition result, and, therefore, a recognition rate of self-repair is insufficient.

It is therefore an object of the present invention to provide a speech recognition device, a speech recognition method and a speech recognition program which are robust against self-repair and hesitation.

### Solution to Problem

A speech recognition device according to the present invention has: hypothesis search means which generates hypotheses being bundles of words which are searched for as recognition result candidates, and searches for an optimal solution of inputted speech data; self-repair decision means which calculates a self-repair likelihood of a word or a word sequence included in the hypothesis which is being searched for by the hypothesis search means, and decides whether or not self-repair of the word or the word sequence is performed; and transparent word hypothesis generation means which, when the self-repair decision means decides that the self-repair is performed, generates a transparent word hypothesis which is a hypothesis which regards as a transparent word a word or a word sequence included in an un-repaired interval related to the word or the word sequence, and the hypothesis search means searches hypotheses for an optimal solution, the hypotheses including as search target hypotheses the transparent word hypothesis generated by the transparent word hypothesis generation means.

Further, the speech recognition method according to the present invention includes in process in which hypothesis search means generates hypotheses being bundles of words which are searched for as recognition result candidates, and searches for an optimal solution of inputted speech data: calculating a self-repair likelihood of a word or a word sequence included in a hypothesis which is being searched for and deciding whether or not self-repair of the word or the word sequence is performed; and when it is decided that the self-repair is performed, generating a transparent word hypothesis which is a hypothesis which regards as a transparent word a word or a word sequence included in an un-repaired interval related to the word or the word sequence, and the hypothesis search means searches hypotheses for an optimal solution, the hypotheses including as search target hypotheses the generated transparent word hypothesis.

Furthermore, a speech recognition program according to the present invention causes a computer in process of hypothesis search processing of generating hypotheses being bundles of words which are searched for as recognition result candidates and searching for an optimal solution of inputted speech data to execute: self-repair decision processing of calculating a self-repair likelihood of a word or a word sequence included in a hypothesis which is being searched for and deciding whether or not self-repair of the word or the word sequence is performed; and transparent word hypothesis generation processing of, when it is decided that the self-repair is performed, generating a transparent word hypothesis which is a hypothesis which regards as a transparent word a word or a word sequence included in an un-repaired interval related to the word or the word sequence, and, in the hypothesis search processing, the computer is caused to search the hypotheses for an optimal solution, the hypotheses including as search target hypotheses the transparent word hypothesis generated by the transparent word hypothesis generation processing.

### Advantageous Effects of Invention

The present invention can provide a speech recognition device, method and program which can prevent a recognition error of a self-repaired interval due to an influence of a recognition error of an un-repaired interval, and, consequently, can reduce false speech recognition of a sound including self-repair and hesitation and are robust against self-repair and hesitation as a result.

### BRIEF DESCRIPTION OF DRAWINGS

FIG. 1 It depicts a block diagram illustrating a configuration example of a speech recognition device according to the present invention.

FIG. 2 It depicts a flowchart illustrating an example of an operation of the speech recognition device according to the present invention.

FIG. 3 It depicts an explanatory view illustrating an example of a hypothesis prior to generation of a hypothesis.

FIG. 4 It depicts an explanatory view illustrating a listing example of hypothesis self-repair intervals.

FIG. 5 It depicts an explanatory view illustrating an example of a hypothesis after a hypothesis that an un-repaired interval is regarded as a transparent word is generated.

FIG. 6 It depicts a block diagram illustrating a summary of the present invention.

### DESCRIPTION OF EMBODIMENTS

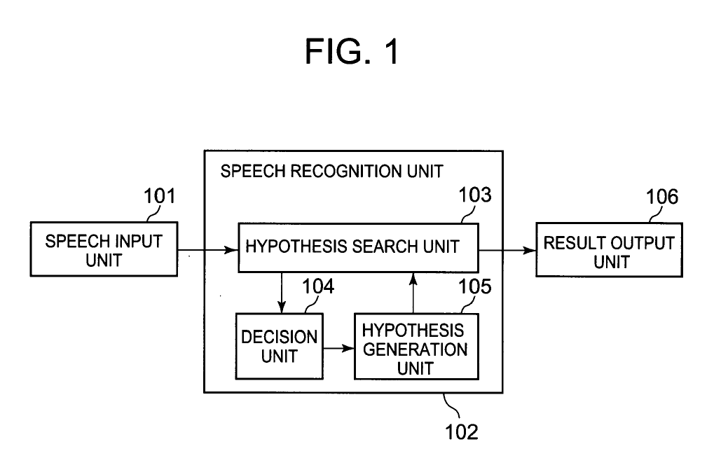

Hereinafter, an exemplary embodiment of the present invention will be described with reference to the drawings. FIG. 1 depicts a block diagram illustrating a configuration example of a speech recognition device according to the present invention. The speech recognition device illustrated in FIG. 1 has a speech input unit 101, a speech recognition unit 102 and a result output unit 106. Further, the speech recognition unit 102 has a hypothesis search unit 103, a decision unit 104 and a hypothesis generation unit 105.

The speech input unit 101 takes in a sound of a speaker as speech data. The speech data is taken in as, for example, a feature sequence of speech. The speech recognition unit 102 receives an input of the speech data, self-recognizes the speech data and outputs a recognition result. The result output unit 106 displays the recognition result of the speech recognition unit 102.

The hypothesis search unit 103 calculates a likelihood of a hypothesis, expands a hypothesis which connects a phoneme and a word leading to each hypothesis, and searches for a solution.

The decision unit 104 hypothesizes an un-repaired interval and a self-repaired interval of a word bundle of each hypothesis, calculates a self-repair likelihood under this hypothesis and decides as a self-repair hypothesis the word bundle having the self-repair likelihood equal to or more than a threshold.

The hypothesis generation unit 105 generates a hypothesis which regards as a transparent word each word of a word sequence of the un-repaired interval of the self-repair hypothesis. In addition, the speech input unit 101 is realized by, for example, a speech input device such as a microphone. Further, the speech recognition unit 102 (including the hypothesis search unit 103, the decision unit 104 and the hypothesis generation unit 105) is realized by, for example, an information processing device such as a CPU which operates according to a program. Furthermore, the result output unit 106 is realized by, for example, an information processing device such as a CPU which operates according to a program, and an output device such as a monitor.

For a self-repair likelihood, linguistic indices such as acoustic information such as whether or not there is a silent pause or whether or not there is a rapid change in power, a pitch and a speaking rate, an acoustic similarity between subwords of an un-repaired interval and a self-repaired interval, and whether or not words of an identical class continue between the un-repaired interval and the self-repaired interval can be used. These indices may be individually used or integrated by linear combination and used.

A word appearing in the un-repaired interval does not necessarily appear only in the un-repaired interval, and therefore a transparent word cannot be statically decided. However, in the present exemplary embodiment, the speech recognition device generates a hypothesis which dynamically regards as a transparent word a word sequence of an un-repaired interval based on a self-repair likelihood which is an index representing the degree that a word or a word sequence included in a hypothetical un-repaired interval or self-repaired interval. The speech recognition device suppresses deterioration of a language likelihood in a self-repair phenomenon using this transparent word.

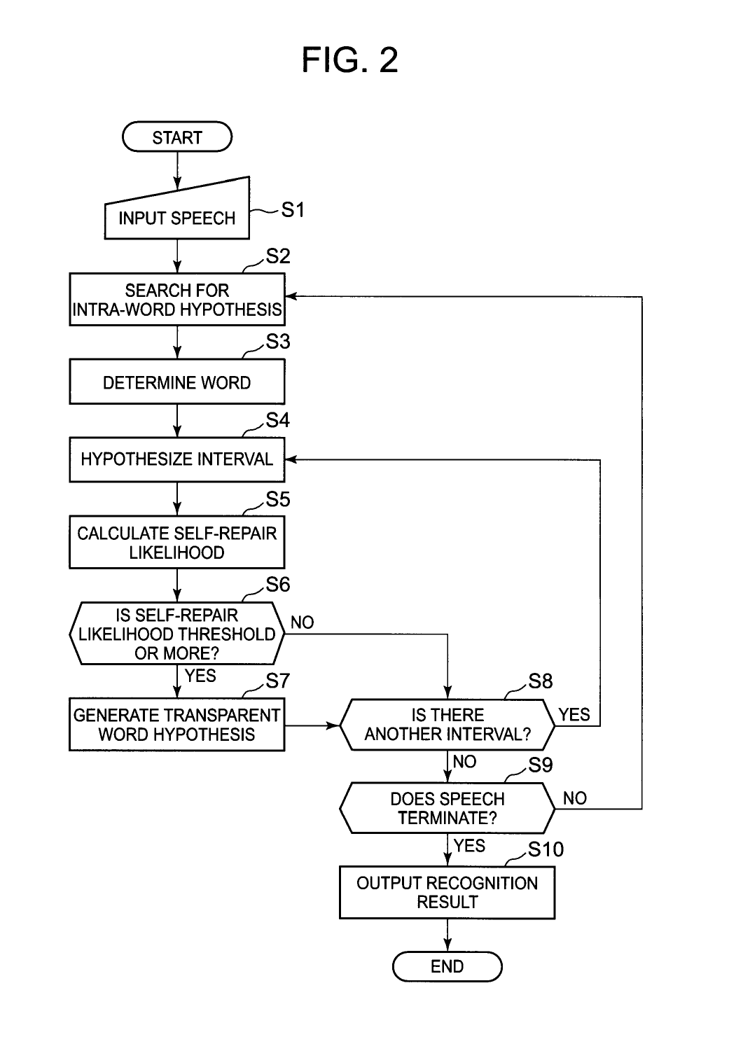

Next, an operation according to the present exemplary embodiment will be described. FIG. 2 depicts a flowchart illustrating an example of an operation of the speech recognition device illustrated in FIG. 1. In an example illustrated in FIG. 2, the speech input unit 101 first takes in a sound of a speaker as speech data (step S1).

Next, the speech recognition unit 102 receives an input of the speech data taken in and self-recognizes the speech data. Hereinafter, the hypothesis search unit 103 first receives an input of the speech data taken in by the speech input unit 101, and calculates a likelihood of an intra-word hypothesis (step S2). In addition, the intra-word hypothesis refers to a unit (group) for regarding as one hypothesis a word of a phoneme with the same anlaut at a portion where which word is not determined, in process of performing search for speech data from before on a time axis. Hence, at a stage of step S2, the hypothesis search unit 103 calculates a likelihood in form of “acoustic likelihood+approximated language likelihood” for the intra-word hypothesis the word of which is not determined. In addition, a language likelihood of a word bundle is accurately calculated and is added the “acoustic likelihood+language likelihood” when the hypothesis reaches a word termination and the word is determined, and then the flow proceeds to S3 in this case.

Next, the hypothesis search unit 103 gives the language likelihood to the hypothesis which reaches the word termination, based on the determined word (step S3).

At a timing when the hypothesis search unit 103 reaches the word termination in process of searching for a hypothesis, the decision unit 104 lists all sets of un-repaired intervals and self-repaired intervals which are likely in the determined word sequence, and extracts a first combination (step S4). Meanwhile, the decision unit 104 hypothesizes an un-repaired interval and a self-repaired interval based on setting information of a self-repair interval set in advance by targeting at a word determined as one type of a word in the hypothesis (that is, the hypothesis which is being searched for) generated by the hypothesis search unit 103. The decision unit 104 includes in the self-repaired interval the word determined in immediate step S3. That is, in this example, calculation of the likelihood of the intra-word hypothesis is finished in step S2, and a word which has just reached a word termination is included. In setting information, an un-repaired interval and a self-repaired interval may be, for example, continuous single words, or the un-repaired interval may be continuous intervals which accommodate N words and the self-repaired interval may be continuous intervals which accommodate M words. In this case, all sets of 1 to N words and 1 to M words may be listed. Hereinafter, the each combination of un-repaired interval and self-repaired interval listed in step S4 is referred to as hypothesis self-repair interval set, and interval obtained by connecting these hypothesis interval is referred to as hypothesis self-repair interval in some cases.

Next, the decision unit 104 calculates a self-repair likelihood of the hypothesis self-repair interval combination extracted in step S4 (step S5). For a self-repair likelihood, indices such as acoustic information such as whether or not there is a silent pause or whether or not there is a rapid change in power, a pitch and a speaking rate, an acoustic similarity between subwords of an un-repaired interval and a self-repaired interval, and whether or not words of an identical class continue between the un-repaired interval and the self-repaired interval can be used.

Further, the decision unit 104 decides whether or not the self-repair likelihood is the threshold or more (step S6). Meanwhile, the decision unit 104 proceeds to step S7 when the self-repair likelihood is the threshold or more, and proceeds to step S8 when the self-repair likelihood is less than the threshold.

In step S7, the hypothesis generation unit 105 generates a hypothesis which regards as a transparent word a word sequence of an un-repaired interval for a hypothesis which includes the hypothesis self-repair interval combination which is decided to include the self-repair likelihood equal to or more than the threshold. Meanwhile, a transparent word refers to a word which is regarded as non-linguistic in speech recognition process. Hence, in case of a transparent word, upon calculation of a language likelihood of a hypothesis, this word is removed to calculate the likelihood.

Next, in step S8, the decision unit 104 checks whether or not there are sets which are not yet processed among the hypothesis self-repair interval sets listed in step S4. When there are sets which are not yet processed, the decision unit 104 returns to step S4, and extracts one combination from the rest of sets (Yes in step S8). Meanwhile, when processing in steps S5 to S7 of all listed hypothesis self-repair interval sets is completed (No in step S8), the decision unit 104 proceeds to step S9.

In step S9, the decision unit 104 decides whether or not hypothesis search is finished to a speech termination. When the hypothesis search is not finished to the speech termination (No in step S9), the flow returns to step S2, the hypothesis generated in step S7 is added as a hypothesis or is replaced with a hypothesis which is decided to be a self-repair and hypothesis search of a next speech frame is performed. When the hypothesis search reaches a speech termination (Yes in step S9), the flow proceeds to step S10.

In step S10, the result output unit 106 outputs a hypothesis which finally has a maximum likelihood as a speech recognition result.

As described above, in the present exemplary embodiment, the speech recognition device dynamically regards as a transparent word a word or a word sequence included in an un-repaired interval of a hypothesis self-repair interval combination which has a higher self-repair likelihood in process of search upon speech recognition, so that it is possible to suppress a decrease in a language likelihood of a correct solution hypothesis of the self-repaired interval. When, for example, processing of dynamically regarding a transparent word in an un-repaired interval extracted in this way is not performed, a recognition error of the un-repaired interval occurs, and therefore a language likelihood of a correct solution hypothesis of the self-repaired interval worsens and a recognition error of the self-repaired interval frequently occurs. However, as in the present exemplary embodiment, a self-repair likelihood of a word or a word sequence included in a hypothesis which is being searched for is sequentially calculated, and a word or a word sequence of an un-repaired interval related to the word or the word sequence, when it is decided that the word or the word sequence is a self-repair, is regarded as a transparent word, so that it is possible to suppress a decrease in the language likelihood of a correct solution hypothesis of the self-repaired interval. Consequently, it is possible to reduce recognition errors of a sound including self-repair.

In addition, although an example has been described with the present exemplary embodiment where self-repair is decided every time a word is determined, a timing to decide self-repair is not limited to this. The hypothesis search unit 103 only needs to be capable of recognizing as a search target a hypothesis (a hypothesis including a transparent word) generated as a result of self-repair decision in addition to a hypothesis which is being searched or in place of this hypothesis. In addition, it is possible to set a timing or conditions to decide self-repair, and, when the timing comes or the conditions match, gradually perform self-repair decision with respect to hypotheses searched so far. For example, when a plurality of word hypotheses is determined in an identical interval, it is also possible to perform self-repair decision.

### Example 1

Next, the exemplary embodiment of the present invention will be described using specific examples. In Example 1, an operation will be described using as an example a case that a sound of “Do you know some someone who can speak Japanese?” is recognized.

In this example, first in step S1, the speech input unit 101 takes in as speech data the sound of “Do you know some someone who can speak Japanese?” of a speaker.

Next, in step S2, the hypothesis search unit 103 calculates the likelihood of the intra-word hypothesis a word of which is not yet determined by targeting at the speech data taken in. This corresponds to, for example, calculating an acoustic likelihood of phoneme models of /i/ and /u/ with respect to the sound of the phoneme of /i/ of a word of “speak” in a sound example, and adding the acoustic likelihood and a language likelihood of a preceding word bundle to the hypothesis such as “can” or “can't”.

Next, in step S3, the hypothesis search unit 103 gives the language likelihood to a hypothesis which reaches a word termination based on the determined word.

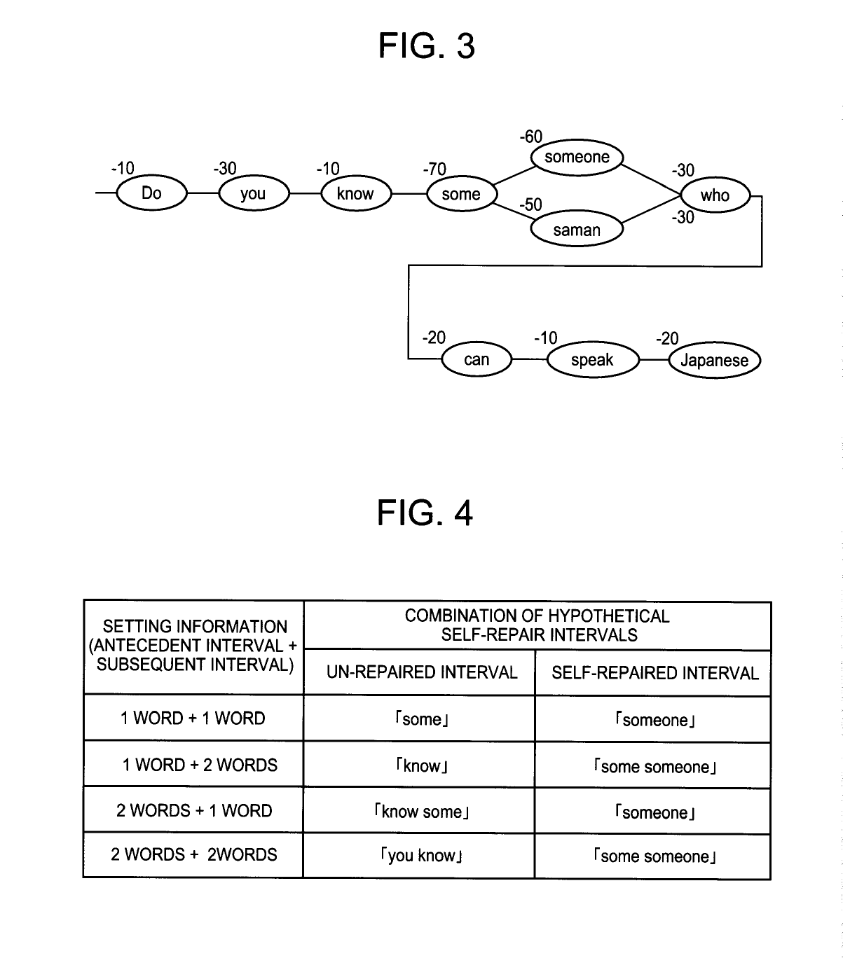

FIG. 3 is an explanatory view illustrating an example of a hypothesis searched in this example. This processing will be described more specifically using the example illustrated in FIG. 3. In FIG. 3, each ellipse indicates a word (word hypothesis) which is searched for as a recognition result candidate. Further, a numerical value assigned to each word hypothesis indicates a log likelihood of a word bundle in a state in which each word hypothesis is concatenated with a preceding word hypothesis.

When a word of “someone” is determined in this example, if a preceding sound of “some” is a word hypothesis of “some”, a language likelihood of a word bundle of “some someone” is given. A log likelihood of “−60” is given in the example illustrated in FIG. 3. A hypothesis of a word bundle of “some saman” is also simultaneously calculated, and a log likelihood of “−50” is given.

Thus, when self-repair is performed, only processing of simply giving a language likelihood to a word bundle cannot differentiate the language likelihood of the word bundle of “some someone” from the language likelihood of the word bundle such as “some saman”, and therefore cannot provide a maximum likelihood hypothesis and causes a recognition error frequently. In addition, a specific method of searching for a hypothesis using an acoustic likelihood or a language likelihood will not be described in detail. Meanwhile, a method adopted upon general speech recognition only needs to be used.

Next, in step S4, the decision unit 104 extracts a first combination by listing sets of un-repaired intervals and self-repaired intervals which are likely in the determined word sequence. The decision unit 104 includes in the self-repaired interval the word determined in step S3. An un-repaired interval and a self-repaired interval may be, for example, continuous single words or the un-repaired interval may be continuous intervals which accommodate N words and the self-repaired interval may be continuous intervals which accommodate M words, and all sets may be listed.

In this sound example, when, for example, the word of “someone” is determined in immediate step S3, following hypothesis self-repair interval sets are listed for a hypothesis of “Do you know some someone who can speak Japanese”.

When, for example, an un-repaired interval and a self-repaired interval are single words, the un-repaired interval is hypothesized as “some” and the self-repaired interval is hypothesized as “someone”. Hence, one combination of hypothesis self-repair intervals is listed. FIG. 4 depicts an explanatory view illustrating a listing example of hypothesis self-repair intervals. In case of an example in FIG. 4, one combination of hypothesis self-repair intervals=(“some”+“someone”) with setting information indicated in a row of (“the number of words in the un-repaired interval+the number of words in the self-repaired interval)=(one word+one word).

Further, when, for example, the un-repaired interval includes one word and the self-repaired interval includes two words, the un-repaired interval is hypothesized as “know” and the self-repaired interval is hypothesized as “some someone”. Hence, one combination of hypothesis self-repair intervals is listed. In addition, when the self-repaired interval includes two words, two sets in total including the above one combination are listed. That is, two sets of the hypothesis self-repair intervals=(“some”+“someone”) with setting information indicated in a row of (the number of words in the un-repaired interval+the number of words in the self-repaired interval)=(one word+one word) and the hypothesis self-repair intervals=(“know”+“some someone”) indicated in a row of (one word+two words) are listed in FIG. 4.

Further, when, for example, the un-repaired interval includes two words and the self-repaired interval includes two words, four sets in total of hypothesis self-repair intervals=(“know some”+“someone”) with setting information indicated in a row of (the number of words in the un-repaired interval+the number of words in the self-repaired interval)=(two words+one word) and hypothesis self-repair intervals=(“you know”+“some someone”) indicated in a row of (two words+two words) are listed in addition to the above sets in FIG. 4.

Next, in step S5, the decision unit 104 calculates a self-repair likelihood of one hypothesis self-repair interval combination extracted in step S4. In this example, acoustic information such as whether or not there is a rapid change in the duration, power, a pitch and a speaking rate of a silent pause is used for an index of a self-repair likelihood. By modeling the acoustic information using learning data with which the self-repair interval is tagged in advance as, for example, a mixture Gaussian distribution in which temporal differentiations of the duration, the power, the pitch and the speaking rate of the silent pause are features, the decision unit 104 calculates the likelihood with the model.

Next, in step S6, the decision unit 104 decides whether or not the self-repair likelihood of the extracted hypothesis self-repair interval is the threshold or more. The decision unit 104 proceeds to step S7 when the self-repair likelihood is the threshold or more, and proceeds to step S8 when the self-repair likelihood is less than the threshold.

In step S7, the hypothesis generation unit 105 generates a hypothesis which regards a word sequence of an un-repaired interval as a transparent word for a hypothesis which includes the self-repair likelihood equal to or more than the threshold, and calculates again the likelihood by removing the word which is linguistically regarded as a transparent word. In addition, the hypothesis search unit 103 may calculate the language likelihood of the generated hypothesis again.

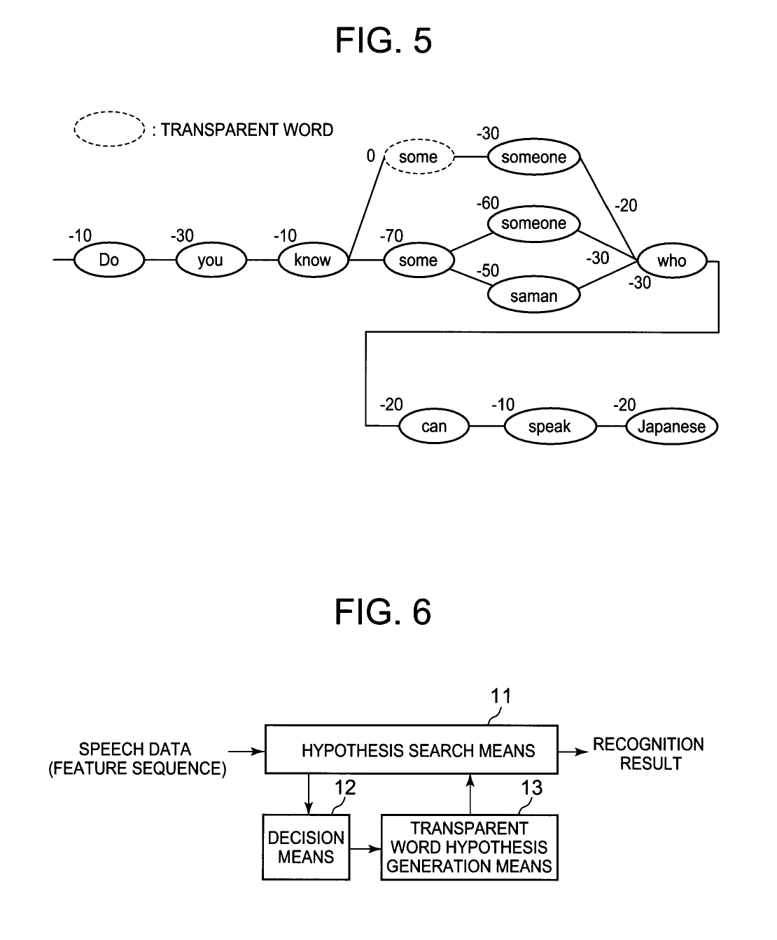

FIG. 5 is an explanatory view illustrating an example of a hypothesis generated when the un-repaired interval is hypothesized as “some” and the self-repaired interval is hypothesized as “someone” in this sound example. In the example illustrated in FIG. 5, “some” of the un-repaired interval is removed and a word bundle is regarded as “Do you know someone who can speak Japanese” to give a language likelihood. Hence, a log likelihood given to the word bundle of “know some” is “0”, and “−30” of a high log likelihood is given to a word bundle of “know someone”. In addition, an acoustic likelihood is not changed.

Next, in step S8, the decision unit 104 checks whether or not other sets of un-repaired intervals and self-repaired intervals listed in step S4 are left. When the other sets are left, the flow returns to step S4, and one combination is extracted from the rest of sets.

Next, in step S9, the decision unit 104 decides whether or not hypothesis search is finished to a speech termination. Meanwhile, when hypothesis search does not reach the speech termination, the flow returns to step S2, and the hypothesis generated in step S7 is added as a hypothesis and hypothesis search of a next speech frame is performed. Meanwhile, when the hypothesis search reaches a speech termination, the flow proceeds to step S10.

In step S10, the result output unit 106 outputs a hypothesis which finally has a maximum likelihood as a speech recognition result.

As described above, although, when hypothesis search is performed by simply giving a language likelihood to a word bundle, the language likelihood of the word bundle of the self-repair interval “some someone” is low and therefore a recognition error of a portion of “someone” occurs frequently, in the example, even when self-repair accompanied by hesitation is performed, the word of “some” included in the un-repaired interval of the hypothesis self-repair interval combination of a higher self-repair likelihood is dynamically regarded as a transparent word. Consequently, it is possible to suppress a decrease in a language likelihood of a subsequent word bundle. Hence, a correct solution hypothesis of “Do you know someone who can speak Japanese” is left as a maximum likelihood hypothesis. Consequently, it is possible to reduce recognition errors of a sound including self-repair.

### Example 2

Next, Example 2 of the present invention will be described. In this example, an acoustic similarity between subwords of an un-repaired interval and a self-repaired interval is used as an index of a self-repair likelihood used by the decision unit 104.

For the acoustic similarity between the subwords of the un-repaired interval and the self-repaired interval, the subword including a head phoneme of the self-repaired interval is first generated, and an editing distance between each subword and the un-repaired interval is calculated. When the un-repaired interval is hypothesized as “some” and the self-repaired interval is hypothesized as “someone”, the subwords of the self-repaired interval are “so”, “some”, “someo” and “someone”. The editing distance of phonemes of “some” (note: sound) and “some” (note: word) of these subwords is 0. When the editing distance is shorter, the acoustic similarity of this interval is made higher by using the editing distance between each subword and the un-repaired interval calculated in this way, the degree of the acoustic similarity may be used for decision as the degree of a self-repair likelihood. Further, by using not only the editing distance but also an inter-phoneme distance between phoneme models of a close phoneme /s/ and phoneme of /sh/, a distance between a word of an un-repaired interval and a subword of a self-repaired interval may be calculated.

### Example 3

Next, Example 3 of the present invention will be described. In this example, a linguistic index of whether or not words of an identical class continue is used as an index of a self-repair likelihood used by the decision unit 104. Whether or not words of the identical class continue is decided based on a similarity between meanings of respective words using a thesaurus. When, for example, it is decided that words representing fruits like “ringo banana” (in Japanese: “apple banana” in English) are continuously sounded between an un-repaired interval and a self-repaired interval, it may be decided that a self-repair likelihood is higher than a threshold.

More specifically, the similarity between meanings of words which continue between the un-repaired interval and the self-repaired interval may be calculated and used for decision assuming that, when the similarity is higher, the self-repair likelihood is higher. Further, when ancillary words such as “ringo ha banana” (in Japanese: “apple is banana is” in English) are accompanied, the ancillary words are removed and an inter-word similarity is calculated. More specifically, when it is recognized that there is a word used as an ancillary word at a boundary between an un-repaired interval and a self-repaired interval, a similarity between meanings of words only needs to be calculated with the ancillary words removed.

### Example 4

In Example 4, each index used in Examples 1 to 3 is linearly combined as an index of a self-repair likelihood used by the decision unit 104.

### Example 5

In Example 5, the speech recognition device decides at step S9 in Examples 1 to 3, whether or not hypothesis search is finished to a speech termination. When it is decided that speech search does not reach a speech termination, upon return to step S2, the speech recognition device replaces the hypothesis generated in step S7 with the hypothesis which is decided to include a self-repair interval and performs hypothesis search of a next speech frame.

In other words, by adding the hypothesis generated in step S7 to a search target hypothesis of the hypothesis search unit 103 and removing hypotheses which do not regard as a transparent word a word or a word sequence included in an interval combination which is decided to be a self-repair, hypothesis search of a next speech frame only needs to be performed.

By performing the operation according to this example, it is possible to output as a recognition result a result from which the hypotheses which are decided to include a self-repair interval. That is, it is possible to remove a recognition result that a recognition error of a self-repair is likely to occur, and consequently expect an effect of preventing subsequent processing from being negatively affected and an effect of reducing a processing burden.

Next, a summary of the present invention will be described. FIG. 6 depicts a block diagram illustrating the summary of the present invention. As illustrated in FIG. 6, the speech recognition device according to the present invention has hypothesis search means 11, self-repair decision means 12 and transparent word hypothesis generation means 13.

The hypothesis search means 11 (for example, the hypothesis search unit 103) generates hypotheses being bundles of words which are searched for as recognition result candidates, and searches for an optimal solution of inputted speech data. Further, the hypothesis search means 11 searches hypotheses for an optimal solution, the hypotheses including as search target hypotheses the transparent word hypothesis generated by the transparent word hypothesis generation means 13.

The self-repair decision means 12 (for example, the decision unit 104) calculates a self-repair likelihood of a word or a word sequence included in the hypothesis which is being searched for by the hypothesis search means 11, and decides whether or not self-repair of the word or the word sequence is performed.

When the self-repair decision means 12 decides that the self-repair is performed, the transparent word hypothesis generation means 13 (for example, the hypothesis generation unit 105) generates a transparent word hypothesis which is a hypothesis which regards as a transparent word a word or a word sequence included in an un-repaired interval related to the word or the word sequence.

Further, by hypothesizing for a word or a word sequence included in a hypothesis which is being searched for by the hypothesis search means 11 a combination of an un-repaired interval which includes the word or the word sequence in the self-repaired interval, and the self-repaired interval, calculating a self-repair likelihood per combination of the hypothesized un-repaired interval and self-repaired interval, and deciding whether or not the calculated self-repair likelihood is a predetermined threshold or more, the self-repair decision means 12 may decide whether or not self-repair of the combination is performed, and the transparent word hypothesis generation means 13 may generate a hypothesis which regards as a transparent word a word or a word sequence included in the un-repaired interval of the combination which is decided by the self-repair decision means 12 to be a self-repair.

Further, the speech recognition device according to the present invention may use as an index of a self-repair likelihood, for example, whether or not there is a rapid change in a duration, power, a pitch and a speaking rate of a silent pause in an expression interval. Furthermore, for example, an acoustic similarity between a word or a word sequence included in the un-repaired interval and a subword of a word or a word sequence included in the self-repaired interval may be used. Still further, for example, whether or not words belonging to an identical class of a meaning continue between the un-repaired interval and the self-repaired interval may be used.

Moreover, the hypothesis search means 11 may perform search by adding the transparent word hypothesis generated by the transparent word hypothesis generation means 13 to an existing hypothesis.

Further, the hypothesis search means 11 may perform search by adding the transparent word hypothesis generated by the transparent word hypothesis generation means 13 to an existing hypothesis, and, when the self-repair decision means 12 decides that self-repair of a word, a word sequence or a combination of an un-repaired interval and a self-repaired interval is performed, removing a hypothesis which does not regard as a transparent word the word or the word sequence included in the self-repaired interval of this set.

Although the present invention has been described above with reference to the exemplary embodiment and the examples, the present invention is by no means limited to the above exemplary embodiment and examples. Configurations and details of the present invention can be variously changed within a scope of the present invention one of ordinary skill in art can understand.

This application claims priority to Japanese Patent Application No. 2011-002306 filed on Jan. 7, 2011, the entire contents of which are incorporated by reference herein.

### INDUSTRIAL APPLICABILITY

The present invention can be widely used in a general speech recognition system. Particularly, the present invention is suitably applicable to a speech recognition system which recognizes speech sounded by a person to a person as in lecture speech or dialogue speech.

### REFERENCE SIGNS LIST

101 speech input unit
102 speech recognition unit
103 hypothesis search unit
104 decision unit
105 hypothesis generation unit
106 result output unit
11 hypothesis search means
12 self-repair decision means
13 transparent word hypothesis generation means

1. A speech recognition device comprising:
a hypothesis search unit which generates hypotheses which is a bundle of words which are searched for as recognition result candidates, and searches for an optimal solution of inputted speech data;
a self-repair decision unit which calculates a self-repair likelihood of a word or a word sequence included in the hypothesis which is being searched for by the hypothesis search unit, and decides whether or not self-repair of the word or the word sequence is performed; and
a transparent word hypothesis generation unit which, when the self-repair decision unit decides that the self-repair is performed, generates a transparent word hypothesis which is a hypothesis which regards as a transparent word a word or a word sequence included in an un-repaired interval related to the word or the word sequence,
wherein the hypothesis search unit searches hypotheses for an optimal solution, the hypotheses including as search target hypotheses the transparent word hypothesis generated by the transparent word hypothesis generation unit.

2. The speech recognition device according to claim 1, wherein:
the self-repair decision unit hypothesizes for the word or the word sequence included in the hypothesis which is being searched for by the hypothesis search unit a combination of the un-repaired interval which includes the word or the word sequence in a self-repaired interval, and the self-repaired interval, calculates a self-repair likelihood per hypothesized combination of the un-repaired interval and the self-repaired interval, decides whether or not the calculated self-repair likelihood is a predetermined threshold or more and thereby decides whether or not the self-repair of the combination is performed; and
the transparent word hypothesis generation unit generates the hypothesis which regards as the transparent word the word or the word sequence included in the un-repaired interval of the combination which is decided by the self-repair decision unit to be a self-repair.

3. The speech recognition device according to claim 2, wherein whether or not there is a rapid change in a duration, power, a pitch and a speaking rate of a silent pause in an expression interval is used as an index of the self-repair likelihood.

4. The speech recognition device according to claim 2, wherein an acoustic similarity between the word or the word sequence included in the un-repaired interval and a subword of the word or the word sequence included in the self-repaired interval is used as an index of the self-repair likelihood.

5. The speech recognition device according to claim 2, wherein whether or not words belonging to an identical class of a meaning between the un-repaired interval and the self-repaired interval continue is used as the index of the self-repair likelihood.

6. The speech recognition device according to claim 1, wherein the hypothesis search unit performs search by adding the transparent word hypothesis generated by the transparent word hypothesis generation unit to an existing hypothesis.

7. The speech recognition device according to claim 1, wherein the hypothesis search unit performs search by adding the transparent word hypothesis generated by the transparent word hypothesis generation unit to an existing hypothesis, and, when self-repair of the word, the word sequence the combination of the un-repaired interval and the self-repaired interval is decided by the self-repair decision unit, removing a hypothesis which does not regard as the transparent word the word or the word sequence included in the self-repaired interval of the set.

8. A speech recognition method comprising in process in which a hypothesis search means generates hypotheses being bundles of words which are searched for as recognition result candidates, and searches for an optimal solution of inputted speech data:
calculating a self-repair likelihood of a word or a word sequence included in a hypothesis which is being searched for and deciding whether or not self-repair of the word or the word sequence is performed; and
generating a transparent word hypothesis which is a hypothesis which regards as a transparent word a word or a word sequence included in an un-repaired interval related to the word or the word sequence when it is decided that the self-repair is performed,
wherein the hypothesis search means searches hypotheses for an optimal solution, the hypotheses including as search target hypotheses the generated transparent word hypothesis.

9. A non-transitory computer readable information recording medium storing a speech recognition program, when executed by a processor, performs a method for, in process of hypothesis search processing of searching for an optimal solution of inputted speech data by generating a hypothesis which is a concatenation of words which are searched for as recognition result candidates:
self-repair decision processing of calculating a self-repair likelihood of a word or a word sequence included in a hypothesis which is being searched for and deciding whether or not self-repair of the word or the word sequence is performed; and
transparent word hypothesis generation processing of, generating a transparent word hypothesis which is a hypothesis which regards as a transparent word a word or a word sequence included in an un-repaired interval related to the word or the word sequence when it is decided that the self-repair is performed,
wherein, in the hypothesis search processing, searching the hypotheses for an optimal solution, the hypotheses including as search target hypotheses the transparent word hypothesis generated by the transparent word hypothesis generation processing.

10. The speech recognition device according to claim 2, wherein the hypothesis search unit performs search by adding the transparent word hypothesis generated by the transparent word hypothesis generation unit to an existing hypothesis.

11. The speech recognition device according to claim 2, wherein the hypothesis search unit performs search by adding the transparent word hypothesis generated by the transparent word hypothesis generation unit to an existing hypothesis, and, when self-repair of the word, the word sequence the combination of the un-repaired interval and the self-repaired interval is decided by the self-repair decision unit, removing a hypothesis which does not regard as the transparent word the word or the word sequence included in the self-repaired interval of the set.
